(19) United States
(12) Patent Application Publication
(10) Pub. No.: US 2020/0370848 A1
(43) Pub. Date: Nov. 26, 2020

(54) IN-PROCESS CLEANING OF THE EXTERNAL SURFACES OF HEAT-TRANSFER TUBES USING A DRY MIXTURE OF SOLID POWDER AND GASES

(71) Applicant: SENTRO Technologies USA, LLC, Irvine, CA (US)

(72) Inventor: Talmor SUCHARD, Irvine, CA (US)

(73) Assignee: SENTRO Technologies USA, LLC, Irvine, CA (US)

(21) Appl. No.: 16/878,706

(22) Filed: May 20, 2020

Related U.S. Application Data
(60) Provisional application No. 62/850,066, filed on May 20, 2019.

(51) Int. Cl. F28G 1/12; B08B 9/023; B08B 5/00; B08B 7/00

(52) U.S. Cl. CPC F28G 1/12; B08B 9/023; B08B 2209/02; B08B 7/00; B08B 5/00

(57) ABSTRACT

Disclosed is a system for in-process cleaning of external surfaces of heat-transfer tubes of a heat-transfer system that removes or delivers heat from or to a process flow, the system may include: a lance to spray a dry-cleaning mixture comprising gases and dry solids, but not liquids, on external surfaces of heat-transfer tubes of the heat-transfer system to remove scale or fouling from the external surfaces for increasing thermal efficiency of the heat-transfer systems during heat transfer operation.

### CROSS-REFERENCE TO RELATED APPLICATIONS

This application claims the benefit of U.S. Provisional Patent Application No. 62/850,066, filed May 20, 2019.

### FIELD OF THE INVENTION

Embodiments of the present invention relate to cleaning or removing scale or other coatings from heat-transfer tubes, generated by different environment conditions, to increase thermal efficiency of the heat-transfer tubes in heating and cooling units. Heating and cooling units may include, but are not limited to, heaters, furnaces, boilers, heat recovery systems (HRS), heat recovery steam generators (HRSG), air pre-heaters, steam or hot-oil coils, radiators, air coolers of different types, cooling towers, after-coolers, and water coolers.

### BACKGROUND OF THE INVENTION

Heat transfer systems can be found through a wide range of industries including, for example, power plants, cement, glass, and steel plants, oil refineries, chemical and petrochemical plants, geothermal and nuclear plants and more.

Some of the heat transfer systems are designed to deliver heat from the energy source or from a utility flow into the process flow. This is called a heating process, for example in heaters, furnaces, boilers, heat recovery systems (HRS), heat recovery steam generators (HRSG), air pre-heaters, steam or hot-oil coils.

Some other heat transfer systems are designed to remove heat from the process flow back to the environment or into a utility flow. This is called a cooling process, for example, in radiators, air coolers, cooling towers, after-coolers, water coolers, or other types of coolers.

High thermal efficiency is an important factor for the performance and cost-effectiveness of cooling or heating systems. Systems with low thermal efficiency will consume more energy and will produce fewer products. In addition, systems with low thermal efficiency will generate more emissions and more pollution. A main goal in the cooling or heating industry, is to increase the thermal efficiency of cooling or heating systems, to the maximum possible.

Scale of different types, also referred to as “fouling factor,” can be generated on the internal or the external surfaces of the process tubes, due to different environmental and process conditions. Scale build-up is a major obstacle that reduces thermal efficiency and thus reduces cost-effectiveness, increases energy consumption, increases emissions, and reduces production flow.

External scale, generated on the external surface of process tubes in both heating and cooling systems, is generally removed during a standard scheduled maintenance service. A standard maintenance service is usually scheduled anywhere between once a year to once every 3 to 6 years, depending of the process unit and the industry. A scheduled maintenance service to heating or cooling system includes a planned shut-down of the system, stabilizing the temperature of the system e.g. to near ambient temperature, opening access to allows persons into the system via dedicated windows or doors, and performing mechanical or chemical cleaning of the scale or fouling deposits using blasting of medium or high pressure water, steam, air, soap, foam, detergents, or other types of media. Because cleaning requires such a major disruption to heating and cooling operation, it is generally scheduled infrequently, allowing the build-up of scale that causes the heating and cooling systems to operate inefficiently.

Accordingly, there is a longstanding need inherent in the art to provide a mechanism to clean scale from the external surfaces of process tubes in heating and cooling systems, without interrupting the operation of the systems.

### SUMMARY OF THE INVENTION

Embodiments of the present invention overcome the aforementioned longstanding need inherent in the art by cleaning external surfaces of process tubes in heating and cooling systems in-process or during operating conditions, i.e., without interrupting their heating or cooling processor shutting down the systems. Such cleaning occurs at full heat or cold of the heating or cooling systems.

Embodiments of the present invention enable cleaning at such extreme temperatures by using a dry-cleaning mixture, i.e., comprising gases and solids, but not liquids. Conventional systems use liquid cleaners, which create a risk of thermal shock when exposed to extreme temperatures due to of the high thermal conductivity of liquids, and so require a system shut down to regulate the temperature in order to clean. In contrast, the dry solid and gas (liquid-free) cleaners of embodiments of the present invention have a relatively low thermal conductivity and so, heat is not significantly transferred between the system and the introduced cleaning mixture (e.g., the introduced cleaning mixture does not significantly affect the temperature of the system). Accordingly, embodiments of the present invention allow in-process cleaning at extreme temperatures without significantly disrupting the heating or cooling operations and without disrupting the integrity of the heating or cooling system metallurgy.

Another benefit of dry or no-liquid cleaning is that it prevents damage to insulation materials, which are common in almost every heating or cooling system. Most of the insulation materials, such as, ceramic fiber, wool, hard refractories such as firebricks or cement, and other insulators, are sensitive to liquids and are often damaged by a contact with liquids, even in small quantities. Cleaning applications of heat transfer tubes that involve liquids may damage insulation and put the integrity of insulation materials in the heating or cooling system at significant risk.

Embodiments of the present invention may use self-dispersive cleaning materials that automatically disappear (e.g., gasses vaporize) or remains in a solid state (e.g., solid powder). This presents an advantage over conventional liquid cleaners that must be collected and removed.

Embodiments of the present invention may simultaneously perform a combination of chemical and mechanical cleaning. Chemical cleaning is provided by the dry-cleaning mixture softening or neutralizing the deposits being cleaned by chemically reacting of bonding thereto. Mechanically cleaning is provided by the dry mixture propelling or agitating the softened scale to clean the deposits by erosion or abrasion.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for in-process cleaning of external surfaces of heat-transfer tubes using a dry mixture of solid powder and gases according to some embodiments of the invention;

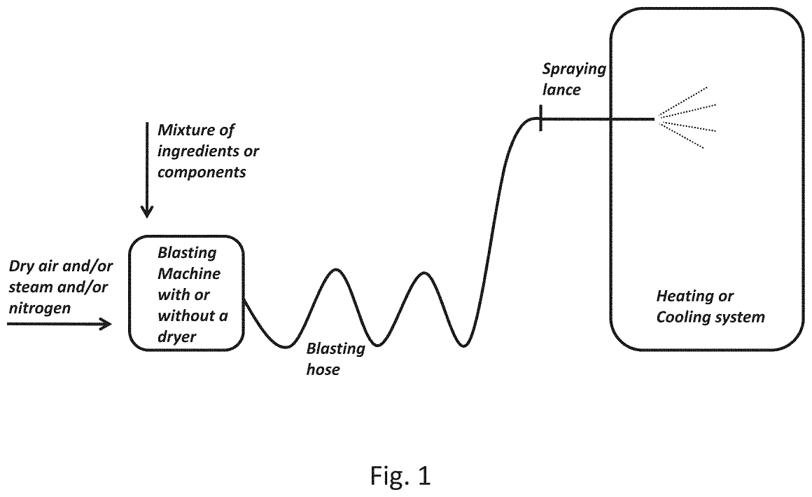

FIG. 2 is a schematic illustration of an in-process cleaning system accessing the heat-transfer tubes through an opening port of a heating or cooling system according to some embodiments of the invention;

FIG. 3 is a schematic illustration of a system for in-process cleaning of an example heating system with smooth heat-transfer tubes oriented vertically according to some embodiments of the invention; and

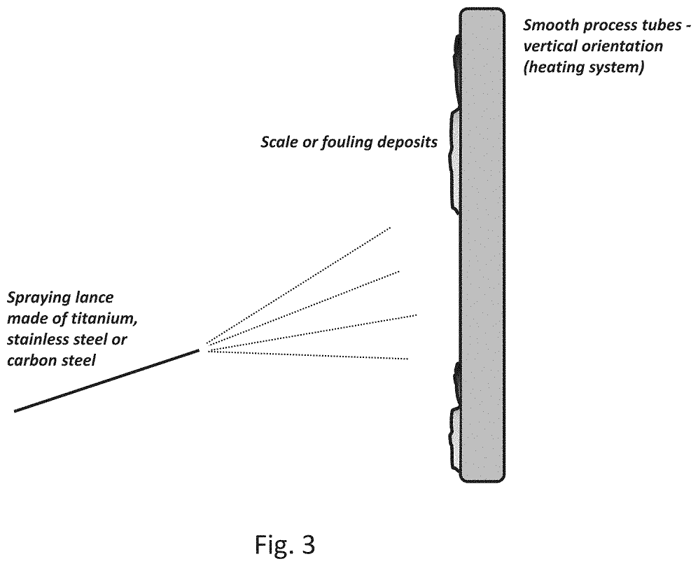

FIG. 4 is a schematic illustration of a system for in-process cleaning of an example heating system with finned heat-transfer tubes oriented vertically according to some embodiments of the invention.

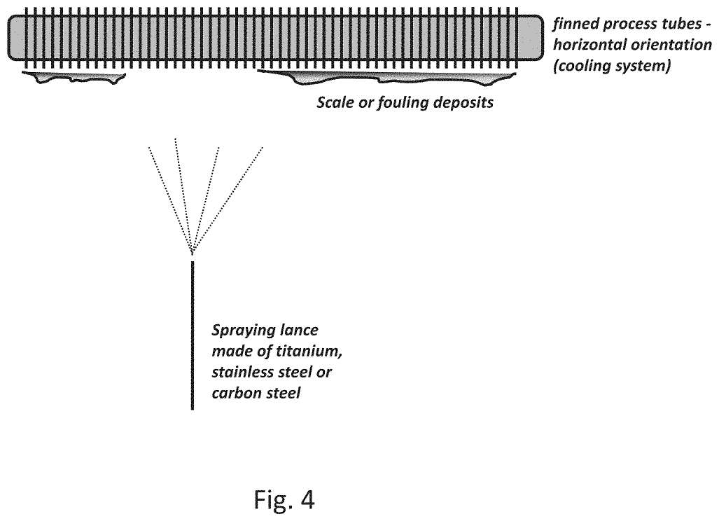

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention are applicable to all types of heating or cooling systems with access to a cleaning port, opening, window, view port or other access point during in-process operation of the system. The removal of scale or fouling deposits can be performed in-process by spraying a dry mixture of air, steam or nitrogen, together with dry solid powder directly onto the external surface of the process tubes.

An advantage of such embodiments is that the removal of scale or fouling deposits can be performed at a flexible timing and is not limited to a specific timing of a planned shut-down. Another benefit is that in-process conditions involve heat, which causes the scale or fouling deposits to become soft and easy to be removed using non-aggressive blasting, rather than during a planned shut-down where the scale or fouling deposits are cold and hard, and need much more aggressiveness i.e. higher blasting pressure of water, steam, air, soap, foam, detergents, or other types of media.

Embodiments of the present invention facilitate benefits of increasing thermal efficiency of various process units such as: heaters, furnaces, boilers, heat recovery systems (HRS), heat recovery steam generators (HRSG), air pre-heaters, steam or hot-oil coils, radiators, air coolers, cooling towers, after-coolers, water coolers, etc. during their in-service conditions, which leads to increased production and cost-effectiveness, reduced energy consumptions, increased flow production, and reduced emissions and pollutions.

In some embodiments of the present inventions, the dry-cleaning mixture is sprayed directly onto the external surface of process tubes, in-service, through cleaning ports, openings, windows, view ports or any other type of access points. The process tubes can be smooth, finned or stubbed, and may be arranged in various orientations, such as, horizontal, vertical or spiral.

In some embodiments, the solid or powder components of the mixture may comprise one or more of the following organic or inorganic ingredients, in different ratios: sodium hydroxide, sodium carbonate, sodium bicarbonate, soda-ash, biuret, silica, silicon, urea, melamine.

The ratios are varied between the different ingredients and components listed above. The exact ratios of a mixture depend on the type of heating or cooling system, its configuration, size, temperatures, access points, metallurgy, and more process-related parameters. The ratios or the presence or absence of one or some of the ingredients or components also depends on environmental or safety restrictions or procedures related to the specific heating or cooling system.

For example, cleaning of some heating systems uses biuret or urea only, while cleaning of other heating systems uses biuret or urea together with silica, silicon or melamine. In another example, cleaning of some cooling systems uses sodium carbonate or sodium bicarbonate only, while cleaning of other cooling systems uses sodium carbonate or sodium bicarbonate and sodium hydroxide or soda-ash.

The particle size of such mixtures depends on the ratio of its ingredients or components, and may vary, for example, between 10 microns to 3 millimeters.

The mixture of different ingredients or components is sprayed onto the external surface of process tubes in heating or cooling systems, in-process, by using dry air and/or saturated or superheated steam and/or nitrogen. The spraying pressure is may be, for example, between 50 to 250 psi.

The usage of dry air and/or saturated or superheated steam and/or nitrogen depends on the type of heating or cooling system, its configuration, size, temperatures, access points, metallurgy, and more process-related parameters. It also depends on environmental or safety restrictions or procedures related to the specific heating or cooling system. For example, in certain heating systems there are requirement to avoid using steam, either saturated or superheated, while in certain cooling systems there are requirements to avoid using nitrogen.

The combination of spraying a dry mixture of ingredients or components together with dry air and/or saturated or superheated steam and/or nitrogen, directly onto the external surface of process tubes in heating or cooling systems, causes the scale of fouling deposits to be removed under relatively non-aggressive conditions, due to the softness of the scale or fouling deposits. In addition, the dry air and/or saturated or superheated steam and/or nitrogen injected together with the dry mixture causes the scale of fouling deposits to break or disperse into very small pieces that can exit the heating or cooling system.

That is another major benefit of embodiments of the present invention, that the scale or fouling deposits are broken into very small pieces that can disperse or exit the heating or cooling system without staying inside. Thus, this cleaning method does not require a secondary cleaning process of both the cleaning media and the removed scale or fouling deposits by vacuuming, flushing, rinsing, washing, sweeping, etc.

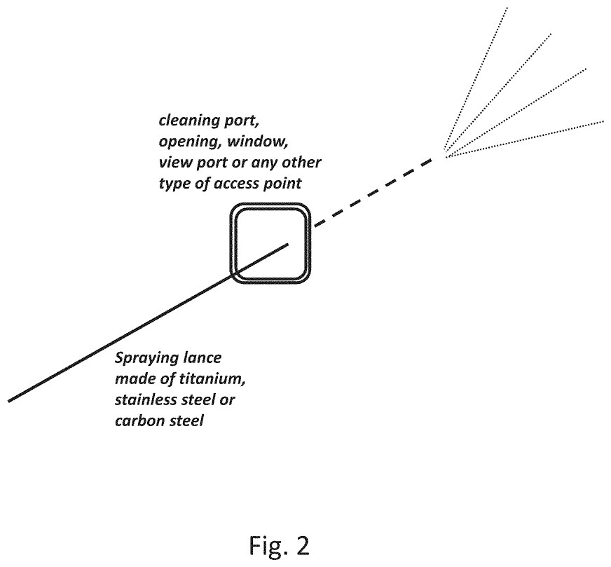

In some embodiments, the dry mixture is sprayed directly onto the external surface of process tubes, while in-service conditions, through cleaning ports, openings, windows, view ports or any other types of access points, e.g., as shown in FIG. 2.

The dry powder may be a mixture comprising one or more of the following different organic or inorganic ingredients or components, in different ratios: sodium hydroxide, sodium carbonate, sodium bicarbonate, soda-ash, biuret, silica, silicon, urea, and melamine. In different applications of different heating or cooling systems some of the ingredients or components listed above might not be present at all. The existence or absence of an ingredients or components depends on the type of heating or cooling system, its configuration, size, temperatures, access points, metallurgy, and more process-related parameters. It also depends on environmental or safety restrictions or procedures related to the specific heating or cooling system.

The dry powder mentioned above may be sprayed together with dry air and/or saturated or superheated steam and/or nitrogen. The existence or absence of air, steam or nitrogen depends on the type of heating or cooling system, its configuration, size, temperatures, access points, metallurgy, and more process-related parameters. It also depends on environmental or safety restrictions or procedures related to the specific heating or cooling system.

The combination of spraying dry power together with dry air and/or saturated or superheated steam and/or nitrogen is sprayed directly onto the external surface of process tubes, in-service (i.e., during operating conditions), through cleaning ports, openings, windows, view ports or any other types of access points. As a result, scale or fouling deposits are removed under relatively non-aggressive conditions, due to the softness of the scale or fouling deposits. In addition, the scale or fouling deposits are broken into very small pieces that can disperse and exit the heating or cooling system without staying inside, thus this cleaning method does not require a cleanup (i.e., a secondary cleaning process of both the cleaning media and the removed scale or fouling deposits by vacuuming, flushing, rinsing, washing, sweeping, etc.)

The spraying of combination of dry power and dry air and/or saturated or superheated steam and/or nitrogen is performed in-process where there is no need to schedule a planned system shut-down. The spraying is performed by usage of a metal lance that is made of e.g., titanium, stainless steel, or carbon steel. The lance material depends on the temperature profile inside the heating or cooling system, for example in high temperature heating systems where the temperature range is between 1000 and 2000 degrees Celsius (C), the lance material can be titanium or stainless steel. In medium temperature heating or cooling systems where the temperature range is typically between 200 and 1000 degrees C., the lance material can be stainless or carbon steel. In low temperature heating or cooling systems where the temperature range is typically between ambient and 200 degrees C., the lance material can be carbon steel. Other lance materials may also be used.

The internal diameter of the lance that sprays combination of dry power and dry air and/or saturated or superheated steam and/or nitrogen can vary, for example, between 10 to 90 millimeters. The total length of a lance can vary, for example, between 100 to 3000 millimeters. The usage of certain internal diameter or total length of a lance depends on a specific application, for example: in a large size heating or cooling system the lance size will be larger, both internal diameter and total length, which in a small size heating or cooling system the lance size will be smaller.

1. A system for in-process cleaning of external surfaces of heat-transfer tubes of a heat-transfer system that removes or delivers heat from or to a process flow, the system comprising:
a lance to spray a dry-cleaning mixture comprising gases and dry solids, but not liquids, on external surfaces of heat-transfer tubes of the heat-transfer system to remove scale or fouling from the external surfaces for increasing thermal efficiency of the heat-transfer systems during heat transfer operation.

2. The system of claim 1, wherein the heat-transfer system is selected from the group consisting of: heaters, furnaces, boilers, heat recovery systems (HRS), heat recovery steam generators (HRSG), air pre-heaters, steam or hot-oil coils, radiators, air cooler, cooling towers, after-coolers, and water coolers.

3. The system of claim 1, wherein the dry-cleaning mixture comprises a mixture of air and/or steam and/or dry powder that are sprayed directly onto the external surfaces of the heat-transfer tubes.

4. The system of claim 1, wherein the spraying pressure of dry air and/or saturated or superheated steam and/or nitrogen is between 50 to 250 psi.

5. The system of claim 1, wherein the dry powder is one or more substances selected from the group consisting of: sodium hydroxide, sodium carbonate, sodium bicarbonate, soda-ash, biuret, silica, silicon, urea, and melamine.

6. The system of claim 1, wherein the lance material is selected from the group consisting of: titanium, stainless steel, and carbon steel.

7. The system of claim 1, wherein the lance has an internal diameter between 10 to 90 millimeters.

8. The system of claim 1, wherein the total length of a lance is between 100 to 3000 millimeters.

9. The system of claim 1, wherein the particle size of the sprayed dry powder is between 10 microns to 3 millimeters.

10. A method for in-process cleaning of external surfaces of heat-transfer tubes of a heat-transfer system that delivers or removes heat comprising spraying a dry-cleaning mixture with the system of claim 1.
